(19) United States
(12) Patent Application Publication
(10) Pub. No.: US 2025/0235859 A1
(43) Pub. Date: Jul. 24, 2025

(54) PROCESS FOR PRODUCING A SINGLE SITE CATALYST

(71) Applicant: W.R. Grace & Co.-CONN., Columbia, MD (US)

(72) Inventors: C. Gail Blakley, Baton Rouge, LA (US); Matthew G. Thorn, Baton Rouge, LA (US)

(73) Assignee: W.R. Grace & Co.-CONN., Columbia, MD (US)

(21) Appl. No.: 18/703,296

(22) PCT Filed: Oct. 14, 2022
(86) PCT No.: PCT/US2022/046774

§ 371 Date: Apr. 19, 2024

Related U.S. Application Data
(60) Provisional application No. 63/257,830, filed on Oct. 20, 2021.

(51) Int. Cl. B01J 37/08; B01J 31/14; B01J 37/00

(52) U.S. Cl. CPC B01J 37/08; B01J 31/143; B01J 37/0045; B01J 2531/31; B01J 2531/90

(57) ABSTRACT

A process for producing a supported single-site catalyst is provided. The process comprises forming a slurry comprising a dried inorganic oxide support, an organic solvent, and an aluminoxane activator; maintaining the temperature of the slurry from about 100° C. to about 200° C. for a time period from about 0.5 to about 10 hours to form a supported aluminoxane slurry; and contacting N the supported aluminoxane slurry with a single-site catalyst component to form a supported single-site catalyst. The organic solvent comprises one or more non-aromatic organic compounds having a boiling point of about 100° C. or greater in an amount of about 50 CA wt. % or greater with respect to the total amount of the organic solvent.

### CROSS REFERENCE TO RELATED APPLICATIONS

This application claims the benefit of priority to U.S. Provisional Patent Application No. 63/257,830 filed Oct. 20, 2021, which is hereby incorporated by reference, in its entirety for any and all purposes.

### FIELD

The present technology is generally related to polyolefin catalyst systems. More specifically, the technology is related to methods for preparing supported aluminoxanes in aliphatic solvents.

### BACKGROUND

Polyolefins are commonly prepared by reacting olefin monomers in the presence of catalysts composed of a support and catalytic components deposited in the pores and on the surfaces of the support. For example, one type of polyolefin catalyst is a single-site catalyst, which typically comprises a support, an activator, and a single-site catalyst component, such as a metallocene component. Aluminoxanes are commonly used as the activator. Such catalysts are conventionally prepared by contacting methylaluminoxane (MAO) dissolved in toluene with a silica support in a toluene slurry to immobilize the aluminoxane activator on the silica support. For example, U.S. Pat. No. 5,856,255 describes such a process. Although the solvent is typically removed from the resulting catalyst, it is difficult to remove all of the toluene and thus polymers produced from the resulting catalysts tend to contain some toluene.

Recently, there has been a push to produce polyolefins with lower levels of aromatic compounds, such as toluene, especially in polyolefins intended for use in the food and beverage industries. As such, there is a need for producing supported single-site catalysts that contain low amounts of toluene, which can be used to produce polyolefins that contain less residual toluene.

### SUMMARY

A process for producing a supported single-site catalyst is provided. In one embodiment, the process comprises forming a slurry comprising a dried inorganic oxide support, an organic solvent, and an aluminoxane activator; maintaining the temperature of the slurry from about 100° C. to about 200° C. for a time period from about 0.5 to about 10 hours to form a supported aluminoxane slurry; and contacting the supported aluminoxane slurry with a single-site catalyst component to form a supported single-site catalyst. The organic solvent comprises one or more non-aromatic organic compounds having a boiling point of about 100° C. or greater in an amount of about 50 wt. % or more with respect to the total amount of the organic solvent.

In one embodiment, the process comprises contacting a dried inorganic oxide support, an organic solvent, and an aluminoxane activator at a temperature from about 0° C. to about 50° C. to form a slurry; heating the slurry to a temperature from about 100° C. to about 200° C. for a time period from about 0.5 to about 10 hours to form a supported aluminoxane slurry; cooling the slurry to a temperature from about 0° C. to about 50° C.; and adding a single-site catalyst component to the supported aluminoxane slurry to form a supported single-site catalyst. The organic solvent comprises one or more non-aromatic organic compounds having a boiling point of about 100° C. or greater in an amount of about 50 wt. % or greater with respect to the total amount of the organic solvent.

A slurry composition is also provided. The slurry comprises a dried inorganic oxide support, an organic solvent, and an aluminoxane activator. The organic solvent comprises one or more non-aromatic organic compounds having a boiling point of about 100° C. or greater in an amount of about 50 wt. % or greater with respect to the total amount of the organic solvent.

Other features and aspects of the present disclosure are discussed in greater detail below.

### DETAILED DESCRIPTION

Before describing several exemplary embodiments, it is to be understood that the invention is not limited to the details of construction or process steps set forth in the following description. The invention is capable of other embodiments and of being practiced or being carried out in various ways.

In general, the present disclosure is directed to a process for producing a supported single-site catalyst using a majority non-aromatic solvent. It was discovered that an aluminoxane activator can be sufficiently immobilized on an inorganic oxide support using a slurry containing the activator, the support, and an organic solvent containing a majority of non-aromatic components having boiling points of about 100° C. or greater when the temperature is raised above 100° C. for a sufficient period of time. A single-site catalyst component can then be added to the supported aluminoxane to form a supported single-site catalyst.

The single-site catalyst can be formed in a single vessel or in a series of vessels. For example, in one embodiment, the supported aluminoxane is produced in one vessel and is then transferred in slurry or isolated form to a second vessel where the single-site catalyst component is added. In another embodiment, a “one-pot” process is used wherein a supported aluminoxane slurry is formed and the single-site catalyst component is added to the slurry in the same vessel used to form the slurry.

The support can be any suitable dehydrated inorganic oxide. Such inorganic oxide support materials include Group IIA, IIIA, IVA or IVB metal oxides such as silica, alumina, silica-alumina and mixtures thereof. Other inorganic oxides that may be employed either alone or in combination with the silica, alumina or silica-alumina are magnesia, chromia, titania, zirconia, and the like. For example, inorganic oxides useful in this invention include without limitation, SiO₂, Al₂O₃, MgO, ZrO₂, TiO₂, B₂O₃, CaO, ZnO, BaO, ThO₂ and double oxides thereof, e.g. SiO₂ Al₂O₃, SiO₂ MgO, SiO₂iO₂, SiO₂—TiO₂—MgO. In one embodiment, the support comprises silica in an amount of about of about 60 wt. % or more, such as about 80 wt. % or more, such as about 90 wt. % or more, such as about 99 wt. % or more.

The specific particle size, surface area, pore diameter, pore volume, etc. of the support materials can be selected as known in the art. For example, particle sizes can range from about 0.1 to 600 micrometers, surface areas can range from about 50 to 1000 m²/g, pore diameters can range from about 50-500 angstroms and pore volumes can range from about 0.3 to 5.0 cc/g.

The inorganic oxide support is dehydrated before forming the slurry with the organic solvent and the aluminoxane activator. For example, supports can be dehydrated either chemically or by heating or calcining the support at a temperature and time sufficient to remove water. For example, drying or calcining the support will typically be conducted by heating the support to temperatures of from about 100° C. to about 1000° C., such as from about 150° C. to about 600° C., such as from about 200° C. to about 300° C. for periods of from about 1 minute to about 100 hours, such as from about 50 minutes to about 5 hours. The atmosphere during drying can be air or an inert gas.

The aluminoxane activator may exist in the form of linear, cyclic, caged or polymeric structures with the simplest monomeric compounds being a tetraalkylaluminoxane such as tetramethylaluminoxane, (CH₃)₂ AlOAl(CH₃)₂, or tetraethylaluminoxane, (C₂ H₅)₂ AlOAl(C₂ H₅)₂. The compounds preferred for use in olefin polymerization catalysts are oligomeric materials, sometimes referred to as polyalkylaluminoxanes, which usually contain about 4 to 20 of the repeating units:

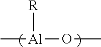

where R is C₁-C₁₀ alkyl, such as polymethylaluminoxanes (MAOs). Although the linear and cyclic aluminoxanes are often noted as having the structures

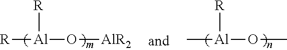

where m and n are integers of 4 or more, the exact configuration of aluminoxanes remains unknown.

Methylaluminoxanes can contain some higher alkyl groups to improve their solubility. Besides MAO, non-limiting examples of hydrocarbylaluminoxanes for use in the invention include ethylaluminoxanes (EAO), isobutylaluminoxanes (IBAO), n-propylaluminoxanes, n-octylaluminoxanes, and the like. The hydrocarbylaluminoxanes can also contain up to about 20 mole percent (based on aluminum) of moieties derived from amines, alcohols, ethers, esters, phosphoric and carboxylic acids, thiols, alkyl disiloxanes and the like to improve activity, solubility and/or stability.

The aluminoxanes can be prepared in any manner known in the art. For example, one suitable method is by the partial hydrolysis of trialkylaluminum compounds. The trialkylaluminum compounds can be hydrolyzed by adding either free water or water containing solids, which can be either hydrates or porous materials which have absorbed water. Because it is difficult to control the reaction by adding water per se, even with vigorous agitation of the mixture, the free water is usually added in the form of a solution or a dispersion in an organic solvent. Suitable hydrates include salt hydrates, such as CuSO₄·5H₂O, Al₂ (SO₄)₃·18H₂O, FeSO₄·7H₂O, AlCl₃·6H₂O, Al(NO₃)₃·9H₂O, MgSO₄·7H₂O, MgCl₂·6H₂O, ZnSO₄·7H₂O, Na₂SO₄·10H₂O, Na₃ PO₄·12H₂O, LiBr·2H₂O, LiCl·1H₂O, LiI·2H₂O, LiI·3H₂O, KF·2H₂O, NaBr·2H₂O and the like, and alkali or alkaline earth metal hydroxide hydrates, such as NaOH·H₂O, NaOH·2H₂O, Ba(OH)₂·8H₂O, KOH·2H₂O, CsOH·1H₂O, LiOH·1H₂O, and the like. Mixtures of any of the above hydrates can be used. The mole ratios of free water or water in the hydrate or in porous materials, such as alumina or silica, to total alkyl aluminum compounds in the mixture can vary widely, such as from about 2:1 to about 1:4, such as from about 4:3 to about 1:3.5.

Such hydrocarbylaluminoxanes and processes for preparing hydrocarbylaluminoxanes are described, for example, in U.S. Pat. Nos. 4,908,463; 4,924,018; 5,003,095; 5,041,583; 5,066,631; 5,099,050; 5,157,008; 5,157,137; 5,235,081; 5,248,801, and 5,371,260, whose entire teachings are incorporated herein by reference. The methylaluminoxanes can contain varying amounts, such as from about 5 to about 35 mole percent, of the aluminum as unreacted trimethylaluminum. In some embodiments, the aluminum content as trimethylaluminum is less than about 23 mole percent of the total aluminum value, and in some embodiments, less than about 20 mole percent.

The aluminoxanes can also be prepared by non-hydrolytic processes, for example, by reaction of an alkyl aluminum compound with an organic compound with one or more oxygen-containing functional groups such as carbonyl, carboxyl, and/or hydroxyl groups; examples of such compounds include PhCOMe, PhCOOH, PhCOOMe, Ph₃COH and the like. Alternatively, a trialkylaluminum can be treated with carbon dioxide.

The organic solvent used to form the slurry containing the support material and the aluminoxane activator generally contains one or more aliphatic hydrocarbon compounds having a boiling point of about 100° C. or more. Such hydrocarbon compounds may be linear or branched, saturated or unsaturated, hydrocarbons having from about 7 to about 20 carbon atoms, in some embodiments from about 7 to about 12 carbon atoms. In some embodiments, the solvent contains saturated hydrocarbons. In some embodiments, the solvent contains branched hydrocarbons. Nonlimiting examples of some suitable linear hydrocarbons include octane, nonane, decane, dodecane, decene, tridecene, and combinations thereof. Suitable branched hydrocarbons include isoparaffins, such as C7-C12 isoparaffins, C7-C10 isoparaffins, and C10-C12 isoparaffins, and those sold under the tradename ISOPAR™ and are manufactured by Exxon Mobil. Illustrative examples of ISOPAR™ include ISOPAR™ E (a mixture of C7-C10 isoparaffins) and ISOPAR™ G (a mixture of C9-C12 isoparaffins). Suitable branched hydrocarbons are isohexadecane, isododecane, 2,5-dimethyl decane, isotetradecane, and combinations thereof. The solvent may also contain mineral oils which are substantially free of aromatic content.

In some embodiments, the organic solvent comprises a cyclic or alicyclic compound, such as a C7-C20 cyclic or alicyclic compound. For example, the solvent may comprise cycloheptane, methylcyclohexane, methylcycloheptane, and mixtures thereof.

The organic solvent generally comprises non-aromatic compounds having boiling points of about 100° C. or more in an amount greater than 50 wt. % relative to the total amount of organic solvent contained in the slurry formed by mixing the organic oxide support, the aluminoxane activator, and the organic solvent. In some embodiments, non-aromatic compounds constitute from about 60 wt. % or more, such as about 70 wt. % or more, such as about 80 wt. % or more, such as about 90 wt. % or more of the organic solvent relative to the total amount of organic solvent contained in the slurry. In some embodiments, non-aromatic compounds constitute from about 60 wt. % to about 100 wt. %, including from about 70 wt. % to about 100 wt. %, from about 80 wt. % to about 100 wt. %, and from about 90 wt. % to about 100 wt. %, of the organic solvent relative to the total amount of organic solvent contained in the slurry. In some embodiments, the slurry is free of aromatic compounds.

In addition to the non-aromatic compounds, the organic solvent can contain aromatic compounds in an amount of 50 wt. % or less. For example, in some embodiments, the aluminoxane activator is introduced to the support and organic solvent in the form of a solution in an aromatic component, such as toluene. When the aluminoxane is introduced as a solution in an aromatic solvent, the aluminoxane can constitute from about 10 to about 50 wt. % of the solution, such as from about 20 to about 40 wt. % of the solution. In some embodiments, when the aluminoxane is introduced as a solution in an aromatic solvent, the aluminoxane constitutes about 10 wt. %, about 15 wt. %, about 20 wt. %, about 25 wt. %, about 30 wt. %, about 35 wt. %, about 40 wt. %, about 45 wt. %, or about 50 wt. % of the solution. Aromatic compounds may also be present in the slurry even when not added with the aluminoxane, such as in a mixture with the inorganic oxide support prior to adding the aluminoxane. In some embodiments, the amount of aromatic compounds contained in the slurry not introduced as a solution of aluminoxane is low, such as about 5 wt. % or less, such as about 1 wt. % or less. In some embodiments, the amount of aromatic compounds contained in the slurry not introduced as a solution of aluminoxane is low, such as from about 0 wt. % to about 5 wt. %, including from about 0 wt. % to about 1 wt. %.

When present, the aromatic solvent preferably has a boiling point of about 100° C. or greater. For example, in some embodiments, aromatic solvents such as toluene, xylenes, ethylbenzene, propylbenzene, cumene, and/or t-butylbenzene can be contained in the organic solvent.

In some embodiments, the organic solvent contains toluene and branched alkanes and/or alicyclic compounds. For example, toluene may be present in amounts from about 40 wt. % to about 50 wt. %, while isoparaffins and/or alicyclic compounds comprise the remainder of the organic solvent.

The solvent generally has a very low amount of contaminants, such as water and non-inert compounds. For example, in some embodiments, the solvent contains about 100 ppm or less, such as about 50 ppm or less, such as about 10 ppm or less of impurities, such as water, polar compounds, non-hydrocarbon compounds, and other non-inert substances. In this regard, in some embodiments, the solvent is purged of air and purified prior to being used to produce a slurry as described herein.

The single site-catalyst component can comprise any transition metal or metallocene single site catalyst known in the art. For example, single-site catalysts can include “half sandwich” and “full sandwich” compounds having one or more Cp ligands (cyclopentadienyl and ligands isolobal to cyclopentadienyl) bound to at least one Group 3 to Group 12 metal atom, and one or more leaving group(s) bound to the at least one metal atom.

The Cp ligands are one or more rings or ring system(s), at least a portion of which includes π-bonded systems, such as cycloalkadienyl ligands and heterocyclic analogues. The ring(s) or ring system(s) typically comprise atoms selected from Groups 13 to 16 atoms, and, in some embodiments, the atoms that make up the Cp ligands are selected from carbon, nitrogen, oxygen, silicon, sulfur, phosphorous, germanium, boron, aluminum, and combinations thereof, where carbon makes up at least 50% of the ring members. For example, the Cp ligand(s) may be selected from substituted and unsubstituted cyclopentadienyl ligands and ligands isolobal to cyclopentadienyl. Non-limiting examples of such ligands include cyclopentadienyl, cyclopentaphenanthrenyl, indenyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, hydrogenated versions thereof (e.g., 4,5,6,7-tetrahydroindenyl, or “H₄ Ind”), substituted versions thereof (as discussed and described in more detail below), and heterocyclic versions thereof.

The metal atom “M” of the single-site compound may be selected from Groups 3 through 12 atoms and lanthanide Group atoms; or may be selected from Groups 3 through 10 atoms; or may be selected from Sc, Ti, Zr, Hf, V, Nb, Ta, Mn, Re, Fe, Ru, Os, Co, Rh, Ir, and Ni; or may be selected from Groups 4, 5, and 6 atoms; or may be Ti, Zr, or Hf atoms; or may be Hf; or may be Zr. The oxidation state of the metal atom “M” can range from 0 to +7; or may be +1, +2, +3, +4 or +5; or may be +2, +3 or +4. The groups bound to the metal atom “M” are such that the compounds described below in the structures are electrically neutral, unless otherwise indicated. The Cp ligand(s) forms at least one chemical bond with the metal atom M to form a “metallocene catalyst component.” The Cp ligands are distinct from the leaving groups bound to metal atom M in that they are not highly susceptible to substitution/abstraction reactions.

In one embodiment, the single-site catalyst may be represented by the following formula:

(C₅Rₓ)_{y}R′_{z}(C₅Rₘ)MQ_{n-y-1}
wherein:
M is a metal of Groups IIIB to VIII of the Periodic Table of the Elements; (C₅Rₓ) and (C₅Rₘ) are the same or different cyclopentadienyl or substituted cyclopentadienyl groups bonded to M;
R is the same or different and is hydrogen or a hydrocarbyl radical such as alkyl, alkenyl, aryl, alkylaryl, or arylalkyl radical containing from 1 to 20 carbon atoms or two carbon atoms are joined together to form a C₄-C₆ ring;
R′ is a C₁-C₄ substituted or unsubstituted alkylene radical, a dialkyl or diaryl germanium or silicon, or an alkyl or aryl phosphine or amine radical bridging two (C₅Rₓ) and (C₅Rₘ) rings;
Q is a hydrocarbyl radical such as aryl, alkyl, alkenyl, alkylaryl, or aryl alkyl radical having from 1-20 carbon atoms, hydrocarboxy radical having from 1-20 carbon atoms or halogen and can be the same or different from each other;
z is 0 or 1;
y is 0, 1 or 2;
z is 0 when y is 0;
n is 0, 1, 2, 3, or 4 depending upon the valence state of M;
and n-y is 1.

Illustrative but non-limiting examples of the metallocenes represented by the above formula are dialkyl metallocenes such as bis(cyclopentadienyl)titanium dimethyl, bis(cyclopentadienyl)titanium diphenyl, bis(cyclopentadienyl)zirconium dimethyl, bis(cyclopentadienyl)zirconium diphenyl, bis(cyclopentadienyl)hafnium dimethyl and diphenyl, bis(cyclopentadienyl)titanium di-neopentyl, bis(cyclopentadienyl)zirconium di-neopentyl, bis(cyclopentadienyl)titanium dibenzyl, bis(cyclopentadienyl)zirconium dibenzyl, bis(cyclopentadienyl)vanadium dimethyl; the mono alkyl metallocenes such as bis(cyclopentadienyl)titanium methyl chloride, bis(cyclopentadienyl)titanium ethyl chloride, bis(cyclopentadienyl)titanium phenyl chloride, bis(cyclopentadienyl)zirconium methyl chloride, bis(cyclopentadienyl)zirconium ethyl chloride, bis(cyclopentadienyl)zirconium phenyl chloride, bis(cyclopentadienyl)titanium methyl bromide; the trialkyl metallocenes such as cyclopentadienyl titanium trimethyl, cyclopentadienyl zirconium triphenyl, and cyclopentadienyl zirconium trineopentyl, cyclopentadienyl zirconium trimethyl, cyclopentadienyl hafnium triphenyl, cyclopentadienyl hafnium trineopentyl, and cyclopentadienyl hafnium trimethyl; monocyclopentadienyls titanocenes such as, pentamethylcyclopentadienyl titanium trichloride, pentaethylcyclopentadienyl titanium trichloride; bis(pentamethylcyclopentadienyl) titanium diphenyl, the carbene represented by the formula bis(cyclopentadienyl)titanium=CH₂ and derivatives of this reagent; substituted bis(cyclopentadienyl)titanium (IV) compounds such as: bis(indenyl)titanium diphenyl or dichloride, bis(methylcyclopentadienyl)titanium diphenyl or dihalides; dialkyl, trialkyl, tetra-alkyl and penta-alkyl cyclopentadienyl titanium compounds such as bis(1,2-dimethylcyclopentadienyl)titanium diphenyl or dichloride, bis(1,2-diethylcyclopentadienyl)titanium diphenyl or dichloride; silicon, phosphine, amine or carbon bridged cyclopentadiene complexes, such as dimethyl silyldicyclopentadienyl titanium diphenyl or dichloride, methyl phosphine dicyclopentadienyl titanium diphenyl or dichloride, methylenedicyclopentadienyl titanium diphenyl or dichloride and other dihalide complexes, and the like; as well as bridged metallocene compounds such as isopropyl(cyclopentadienyl)(fluorenyl)zirconium dichloride, isopropyl(cyclopentadienyl) (octahydrofluorenyl)zirconium dichloride diphenylmethylene(cyclopentadienyl)(fluorenyl) zirconium dichloride, diisopropylmethylene (cyclopentadienyl)(fluorenyl)zirconium dichloride, diisobutylmethylene(cyclopentadienyl)(fluorenyl) zirconium dichloride, ditertbutylmethylene (cyclopentadienyl)(fluorenyl)zirconium dichloride, cyclohexylidene(cyclopentadienyl)(fluorenyl) zirconium dichloride, diisopropylmethylene (2,5-dimethylcyclopentadienyl)(fluorenyl)zirconium dichloride, isopropyl(cyclopentadienyl)(fluorenyl) hafnium dichloride, diphenylmethylene (cyclopentadienyl) (fluorenyl)hafnium dichloride, diisopropylmethylene(cyclopentadienyl) (fluorenyl)hafnium dichloride, diisobutylmethylene(cyclopentadienyl) (fluorenyl)hafnium dichloride, ditertbutylmethylene(cyclopentadienyl) (fluorenyl)hafnium dichloride, cyclohexylidene(cyclopentadienyl)(fluorenyl)hafnium dichloride, diisopropylmethylene(2,5-dimethylcyclopentadienyl) (fluorenyl)hafnium dichloride, isopropyl(cyclopentadienyl)(fluorenyl)titanium dichloride, diphenylmethylene(cyclopentadienyl) (fluorenyl)titanium dichloride, diisopropylmethylene(cyclopentadienyl) (fluorenyl)titanium dichloride, diisobutylmethylene(cyclopentadienyl) (fluorenyl)titanium dichloride, ditertbutylmethylene(cyclopentadienyl) (fluorenyl)titanium dichloride, cyclohexylidene(cyclopentadienyl) (fluorenyl)titanium dichloride, diisopropylmethylene(2,5 dimethylcyclopentadienyl fluorenyl)titanium dichloride, racemic-ethylene bis(1-indenyl) zirconium (IV) dichloride, racemic-ethylene bis(4,5,6,7-tetrahydro-1-indenyl) zirconium (IV) dichloride, racemic-dimethylsilyl bis(1-indenyl) zirconium (IV) dichloride, racemic-dimethylsilyl bis(4,5,6,7-tetrahydro-1-indenyl) zirconium (IV) dichloride, racemic-1,1,2,2-tetramethylsilanylene bis(1-indenyl) zirconium (IV) dichloride, racemic-1,1,2,2-tetramethylsilanylene bis(4,5,6,7-tetrahydro-1-indenyl) zirconium (IV), dichloride, ethylidene (1-indenyl tetramethylcyclopentadienyl) zirconium (IV) dichloride, racemic-dimethylsilyl bis(2-methyl-4-t-butyl-1-cyclopentadienyl) zirconium (IV) dichloride, racemic-ethylene bis(1-indenYl) hafnium (IV) dichloride, racemic-ethylene bis(4,5,6,7-tetrahydro-1-indenyl) hafnium (IV) dichloride, racemic-dimethylsilyl bis(1-indenyl) hafnium (IV) dichloride, racemic-dimethylsilyl bis(4,5,6,7-tetrahydro-1-indenyl) hafnium (IV) dichloride, racemic-1,1,2,2-tetramethylsilanylene bis(1-indenyl) hafnium (IV) dichloride, racemic-1,1,2,2-tetramethylsilanylene bis(4,5,6,7-tetrahydro-1-indenyl) hafnium (IV), dichloride, ethylidene (1-indenyl-2,3,4,5-tetramethyl-1-cyclopentadienyl) hafnium (IV) dichloride, racemic-ethylene bis(1-indenyl) titanium (IV) dichloride, racemic-ethylene bis(4,5,6,7-tetrahydro-1-indenyl) titanium (IV) dichloride, racemic-dimethylsilyl bis(1-indenyl) titanium (IV) dichloride, racemic-dimethylsilyl bis(4,5,6,7-tetrahydro-1-indenyl) titanium (IV) dichloride, racemic-1,1,2,2-tetramethylsilanylene bis(1-indenyl) titanium (IV) dichloride racemic-1,1,2,2-tetramethylsilanylene bis(4,5,6,7-tetrahydro-1-indenyl) titanium (IV) dichloride, bis(1-methy-3-butylcyclopentadienyl) zirconium dichloride, and ethylidene (1-indenyl-2,3,4,5-tetramethyl-1-cyclopentadienyl) titanium IV) dichloride.

Single site catalyst components are described, for example, in U.S. Pat. Nos. 2,864,843; 2,983,740; 4,665,046: 4,874,880; 4,892,851; 4,931,417; 4,952,713; 5,017,714: 5,026,798; 5,036,034; 5,064,802; 5,081,231; 5,145,819; 5,162,278: 5,245,019; 5,268,495; 5,276,208: 5,304,523; 5,324,800; 5,329,031: 5,329,033; 5,330,948, 5,347,025; 5,347,026; and 5,347,752, whose teachings with respect to such components are incorporated herein by reference.

To form the single-site catalyst, a slurry is formed containing the support, the aluminoxane, and the organic solvent. For example, in one embodiment, the dried inorganic oxide support is mixed with a portion of the organic solvent to form a slurry. The slurry can be formed in any suitable vessel using any suitable mixing means. For example, in one embodiment, the vessel may be fitted with a condenser and a stirrer or impeller. The vessel can be an open or closed reactor. The aluminoxane can then be added to the slurry. For example, in one embodiment, the aluminoxane is added in the form of a solution in an organic solvent to form a slurry containing the support, aluminoxane, and organic solvent. In such embodiments, the total organic solvent includes both the organic solvent used to slurry the support and the organic solvent added with the aluminoxane.

In one embodiment, the weight ratio of aluminoxane added to the support is from about 0.5:1 to about 5:1, such as from about 1:1 to about 3:1, such as from about 2:1 to about 2.5:1. Notably, if the aluminoxane is dissolved in an aromatic solvent, it should not be added in an amount such that the resulting organic solvent after the addition contains more than 50 wt. % of aromatic compounds.

In one embodiment, the slurry is formed at a temperature between 0° C. and 50° C., such as from about 15° C. to about 30° C. In one embodiment, the slurry is formed at a temperature of about 0° C., about 5° C., about 10° C., about 15° C., about 20° C., about 25° C., about 30° C., about 35° C., about 40° C., about 45° C., or about 50° C. In one embodiment, the slurry remains in such a temperature range for a time period from about 1 min to about 2 hours, such as from about 10 min to about 1 hour, while mixing the slurry.

It was discovered that, in order to sufficiently immobilize the aluminoxane activator on the support, the temperature must be maintained at about 100° C. or greater for a sufficient time period. Therefore, in one embodiment, the temperature of the slurry is raised to a temperature of about 100° C. or greater, such as about 110° C. or greater, such as about 120° C. or greater, such as about 130° C. or greater, such as about 140° C., such as about 150° C. or greater. Typically, the temperature remains less than about 200° C. Therefore, in one embodiment, the temperature of the slurry is raised to a temperature of from about 100° C. to about 200° C., including from about 110° C. to about 200° C., from about 120° C. to about 200° C., from about 130° C. to about 200° C., from about 140° C. to about 200° C., and from about 150° C. to about 200° C. However, depending on the solvent and the pressure of the reactor, the temperature can be greater than about 200° C. The temperature can be maintained for a time period from about 0.5 to about 10 hours, such as from about 2 hours to about 6 hours to form a supported aluminoxane slurry. In one embodiment, the temperature of the slurry is kept below the boiling point of the organic solvent. In one embodiment, the pressure is maintained at about 130 kPa or less, such as from about 90 to about 130 kPa and from about 90 to about 110 kPa, throughout the process. In one embodiment, the pressure is maintained at about 90 kPa, about 95 kPa, about 100 kPa, about 105 kPa, about 110 kPa, about 115 kPa, about 120 kPa, about 125 kPa, or about 130 kPa, throughout the process. However, in some embodiments, when using a closed reactor system, the pressure can be elevated above 130 kPa and brought to temperatures above the atmospheric boiling point of the solvent.

After the supported aluminoxane slurry is formed, the slurry can be cooled to a temperature of about 50° C. or lower, such as from about 15° C. to about 50° C. or from about 15° C. to about 30° C. In some embodiments, after the supported aluminoxane slurry is formed, the slurry is cooled to a temperature of about 15° C., about 20° C., about 25° C., about 30° C., about 35° C., about 40° C., about 45° C., or about 50° C. For example, in one embodiment, the slurry is allowed to gradually cool back to room temperature.

After the supported aluminoxane slurry is formed, it is contacted with a single-site catalyst component to form the supported single-site catalyst. The single-site catalyst component can be loaded onto the supported aluminoxane in any manner known in the art.

In one embodiment, for example, the slurry can be separated from the solvent, optionally stored, and later combined with the single-site catalyst component. In another embodiment, the slurry can be combined with the single-site catalyst component in a separate vessel. Alternatively, in another embodiment, a “one pot” process can be used in which, after the slurry is cooled, the single site catalyst component is added to the supported aluminoxane slurry in the same vessel the slurry was formed in.

In any of such embodiments, the single-site catalyst component can be added to the supported aluminoxane as a solution in a solvent, such as toluene. The mixture of the single-site catalyst component and supported aluminoxane can then be mixed, such as by stirring, for a time period sufficient to load the catalyst component on the support. For example, the single-site catalyst component can be added to the supported aluminoxane in a slurry and stirred at a temperature from about 0° C. to about 50° C., such as from about 15° C. to about 30° C. for a time from about 5 min to about 5 hours, such as from about 1 hour to about 3 hours.

Additionally, in some embodiments, the single site catalyst component can be treated prior to combining with the supported aluminoxane. For example, pretreatments could include treating the single site catalyst component with Al-, Mg-, Zn-, other main group alkyls (e.g., TEA, TIBA, MgBu2, ZnEt2), borates, olefins, Lewis bases, or any combination thereof, as known in the art.

In one embodiment, the weight ratio of the catalyst component added to the supported aluminoxane is from about 1:25 to about 1:200, such as from about 1:50 to about 1:100, such as from about 1:60 to about 1:90.

The resulting solid single-site catalyst can then be separated from the solvent by any suitable means, such as by filtering and washing in a non-aromatic organic liquid and then drying, such as by drying under vacuum.

In some embodiments, the solid single-site catalyst has a total residual solvent content of less than about 50 wt %, including less than about 40 wt %, less than about 30 wt %, less than about 20 wt %, less than about 10 wt %, less than about 5 wt %, less than about 4 wt %, less than about 3% wt %, less than about 2 wt %, less than about 1 wt %, less than about 0.5 wt %, and less than about 0.1 wt %. In some embodiments, the solid single-site catalyst has a total residual solvent content of less than about 5 wt % or less than about 2 wt %. In some embodiments, the solid single-site catalyst has a total residual solvent content of from about 0 wt % to about 50 wt %, from about 0 wt % to about 5% wt, from about 0 wt % to about 2 wt %, and from about 0 wt % to about 1 wt %. In some embodiments, the solid single-site catalyst has a total residual solvent content of from about 0.1 wt % to about 50 wt %, from about 0.1 wt % to about 5% wt, from about 0.1 wt % to about 2 wt %, from about 0.1 wt % to about 1 wt %, and from about 0.1 wt % to about 0.5 wt %. In some embodiments, the solid single-site catalyst has a total residual solvent content of from about 0.01 wt % to about 50 wt %, from about 0.01 wt % to about 5% wt, from about 0.01 wt % to about 2 wt %, from about 0.01 wt % to about 1 wt %, from about 0.01 wt % to about 0.5 wt %, and from about 0.01 wt % to about 0.1 wt %.

In some embodiments, total residual solvent content comprises residual isohexanes content. In some embodiments, total residual solvent content comprises total residual aromatic solvent content (e.g., residual toluene content). In some embodiments, total residual solvent content comprises residual isohexanes content. In some embodiments, total residual solvent content comprises total residual aromatic solvent content (e.g., residual toluene content).

In some embodiments, the solid single-site catalyst has a total residual aromatic solvent content (e.g. toluene solvent content) of less than about 50 wt %, including less than about 40 wt %, less than about 30 wt %, less than about 20 wt %, less than about 10 wt %, less than about 5 wt %, less than about 4 wt %, less than about 3% wt %, less than about 2 wt %, less than about 1 wt %, less than about 0.5 wt %, and less than about 0.1 wt % and less than about 0.01 wt %. In some embodiments, the solid single-site catalyst has a total residual aromatic solvent content (e.g. toluene solvent content) of less than about 0.5 wt %. In some embodiments, the solid single-site catalyst has a total residual aromatic solvent content of from about 0 wt % to about 50 wt %, from about 0 wt % to about 5% wt, from about 0 wt % to about 2 wt %, and from about 0 wt % to about 1 wt %. In some embodiments, the solid single-site catalyst has a total residual aromatic solvent content of from about 0.1 wt % to about 50 wt %, from about 0.1 wt % to about 5% wt, from about 0.1 wt % to about 2 wt %, from about 0.1 wt % to about 1 wt %, and from about 0.1 wt % to about 0.5 wt %. In some embodiments, the solid single-site catalyst has a total residual aromatic solvent content of from about 0.01 wt % to about 50 wt %, from about 0.01 wt % to about 5% wt, from about 0.01 wt % to about 2 wt %, from about 0.01 wt % to about 1 wt %, from about 0.01 wt % to about 0.5 wt %, and from about 0.01 wt % to about 0.1 wt %.

In some embodiments, the solid single-site catalyst has a residual isohexanes content content of less than about 50 wt %, including less than about 40 wt %, less than about 30 wt %, less than about 20 wt %, less than about 10 wt %, less than about 5 wt %, less than about 4 wt %, less than about 3% wt %, less than about 2 wt %, less than about 1 wt %, less than about 0.5 wt %, and less than about 0.1 wt % and less than about 0.01 wt %. In some embodiments, the solid single-site catalyst has a residual isohexanes content of less than about 0.5 wt %. In some embodiments, the solid single-site catalyst has a residual isohexanes content of from about 0 wt % to about 50 wt %, from about 0 wt % to about 5% wt, from about 0 wt % to about 2 wt %, and from about 0 wt % to about 1 wt %. In some embodiments, the solid single-site catalyst has a residual isohexanes content of from about 0.1 wt % to about 50 wt %, from about 0.1 wt % to about 5% wt, from about 0.1 wt % to about 2 wt %, from about 0.1 wt % to about 1 wt %, and from about 0.1 wt % to about 0.5 wt %. In some embodiments, the solid single-site catalyst has a residual isohexanes content of from about 0.01 wt % to about 50 wt %, from about 0.01 wt % to about 5% wt, from about 0.01 wt % to about 2 wt %, from about 0.01 wt % to about 1 wt %, from about 0.01 wt % to about 0.5 wt %, and from about 0.01 wt % to about 0.1 wt %.

The present invention, thus generally described, will be understood more readily by reference to the following examples, which are provided by way of illustration and are not intended to be limiting of the present invention.

### EXAMPLES

Five catalysts were formed by immobilizing methylaluminoxane and a metallocene catalyst component (Bis(1-methy-3-butylcyclopentadienyl) zirconium dichloride) on dehydrated silica. After forming each catalyst, the relative production rates were obtained using the same polymerization test conditions for each.

A typical polymerization process was as follows: A 4-L liter autoclave was charged with isobutane (900 g), 1-hexene (28 g), TIBA (0.5 mL of 20% solution in isohexane), catalyst (0.025 g), and ethylene (125 psi). The contents were stirred at 800 RPM using a marine impeller. The polymerization temperature was 85° C. The polymerization time was 1 hour. Resin was collected after venting and cooling the reactor after the 1-hour run time. Resin was obtained after drying under vacuum at 65° C. Catalyst activity (g polymer/g catalyst per hour) was determined by dividing the amount of polymer made by the amount of catalyst added.

### Example 1

### Formation of Supported Aluminoxane Slurry

Dehydrated silica (7.5 g) was slurried in methylcyclohexane (55.8 g) in a 250 mL, 3-neck flask fitted with an overhead stirring arm and condenser. MAO (17.2 g, 30 wt. % in toluene) was added, and the resulting slurry was stirred at room temperature for 30 minutes. The internal temperature was raised to 100° C. and held for 4 hours. The supported methylaluminoxane (sMAO) slurry was cooled back down to ambient temperature.

### Formation of Catalyst

Bis(1-methy-3-butylcyclopentadienyl) zirconium dichloride (0.22 g, 25 wt % in toluene) was added to an aliquot of the sMAO slurry (17.2 g, 17.2 wt. % solids) and stirred for 2 hours at room temperature. The solids were collected on a coarse fritted disc filter and washed with 1×20 mL of methylcyclohexane and 3×20 mL of isohexane. The solids were dried under vacuum until constant mass (0.38 wt % residual toluene, 0.24 wt % residual isohexanes).

### Polymerization

Polymerization was conducted of the process described above. The average polymer production rate was 5,051 g/g catalyst/hour.

### Example 2

### Formation of Supported Aluminoxane Slurry

Dehydrated silica (7.6 g) was slurried in ISOPAR™ G (a mixture of C9-C12 isoparaffins having less than 2 wt. % aromatic content) (41.5 g) in a 250 mL, 3-neck flask fitted with an overhead stirring arm and condenser. MAO (17.3 g, 30 wt. % in toluene) was added, and the resulting slurry was stirred at room temperature for 30 minutes. The internal temperature was raised to 120° C. and held for 4 hours. The sMAO slurry was cooled back down to ambient temperature.

### Formation of Catalyst

Bis(1-methy-3-butylcyclopentadienyl) zirconium dichloride (0.22 g, 25 wt % in toluene) was added to an aliquot of the sMAO slurry (16.9 g, 18.2 wt. % solids) and stirred for 2 hours at room temperature. The solids were collected on a coarse fritted disc filter and washed with 1×20 mL of ISOPAR™ G (an isoparaffin mixture) and 3×20 mL of isohexane. The solids were dried under vacuum until constant mass (0.02 wt % residual toluene, 1.27 wt % residual isohexanes).

### Polymerization

Polymerization was conducted of the process described above. The average polymer production rate was 5,576 g/g catalyst/hour.

### Example 3

### Formation of Supported Aluminoxane Slurry

Dehydrated silica (7.0 g) was slurried in ISOPAR™ E (a mixture of C7-C10 isoparaffins) (53.5 g) in a 250 mL, 3-neck flask fitted with an overhead stirring arm and condenser. MAO (15.9 g, 30 wt. % in toluene) was added, and the resulting slurry was stirred at room temperature for 30 minutes. The internal temperature was raised to 120° C. and held for 4 hours. The sMAO slurry was cooled back down to ambient temperature.

### Formation of Catalyst

Bis(1-methy-3-butylcyclopentadienyl) zirconium dichloride (0.22 g, 25 wt % in toluene) was added to an aliquot of the sMAO slurry (14.8 g, 17.2 wt. % solids) and stirred for 2 hours at room temperature. The solids were collected on a coarse fritted disc filter and washed with 1×20 mL of ISOPAR™ E (an isoparaffin mixture) and 3×20 mL of isohexane. The solids were dried under vacuum until constant mass (0.02 wt % residual toluene, 0.45 wt % residual isohexanes).

### Polymerization

Polymerization was conducted of the process described above. The average polymer production rate was 5,485 g/g catalyst/hour.

### Example 4

### Formation of Supported Aluminoxane Slurry

Dehydrated silica (5.7 g) was slurried in ISOPAR™ G (42.5 g) in a 250 mL, 3-neck flask fitted with an overhead stirring arm and condenser. MAO (12.9 g, 30 wt. % in toluene) was added, and the resulting slurry was stirred at room temperature for 30 minutes. The internal temperature was raised to 150° C. and held for 4 hours. The sMAO slurry was cooled back down to ambient temperature.

### Formation of Catalyst

Bis(1-methyl-3-butylcyclopentadienyl) zirconium dichloride (0.8 g, 25 wt % in toluene) was added to the sMAO slurry and stirred for 2 hours at room temperature. The solids were collected on a coarse fritted disc filter and washed with 1×20 mL of ISOPAR™ G (an isoparaffin mixture) and 3×20 mL of isohexane. The solids were dried under vacuum until constant mass (0.13 wt % residual toluene, 0.62 wt % residual isohexanes).

### Polymerization

Polymerization was conducted of the process described above. The average polymer production rate was 6,548 g/g catalyst/hour.

### Example 5 (Comparative)

### Formation of Supported Aluminoxane Slurry

Dehydrated silica (7.4 g) was slurried in ISOPAR™ G (55.8 g) in a 250 mL, 3-neck flask fitted with an overhead stirring arm and condenser. MAO (16.9 g, 30 wt. % in toluene) was added, and the resulting slurry was stirred at room temperature for 30 minutes. The internal temperature was raised to 60° C. and held for 4 hours. The sMAO slurry was cooled back down to ambient temperature.

### Formation of Catalyst

Bis(1-methyl-3-butylcyclopentadienyl) zirconium dichloride (1.0 g, 25 wt % in toluene) was added to the sMAO slurry and stirred for 2 hours at room temperature. The solids were collected on a coarse fritted disc filter and washed with 1×20 mL of ISOPAR™ G (an isoparaffin mixture) and 3×20 mL of isohexane. The solids were dried under vacuum until constant mass.

### Polymerization

Polymerization was conducted of the process described above. The average polymer production rate was 3,302 g/g catalyst/hour.

### Example 6 (Comparative)

### Formation of Supported Aluminoxane Slurry

Dehydrated silica (5.7 g) was slurried in ISOPAR™ G (36.3 g) in a 250 mL, 3-neck flask fitted with an overhead stirring arm and condenser. MAO (13.0 g, 30 wt. % in toluene) was added, and the resulting slurry was stirred at room temperature for 4.5 hours.

### Formation of Catalyst

Bis(1-methyl-3-butylcyclopentadienyl) zirconium dichloride (0.8 g, 25 wt % in toluene) was added to the sMAO slurry and stirred for 2 hours at room temperature. The solids were collected on a coarse fritted disc filter and washed with 1×20 mL of ISOPAR™ G (an isoparaffin mixture) and 3×20 mL of isohexane. The solids were dried under vacuum until constant mass.

### Polymerization

Polymerization was conducted of the process described above. The average polymer production rate was 3,339 g/g catalyst/hour.

Para. 1. A process for producing a supported single-site catalyst comprising:
forming a slurry comprising a dried inorganic oxide support, an organic solvent, and an aluminoxane activator;
maintaining the temperature of the slurry from about 100° C. to about 200° C. for a time period from about 0.5 to about 10 hours to form a supported aluminoxane slurry; and
contacting the supported aluminoxane slurry with a single-site catalyst component to form a supported single-site catalyst;
wherein the organic solvent comprises one or more non-aromatic organic compounds having a boiling point of about 100° C. or greater in an amount of about 50 wt. % or greater with respect to the total amount of the organic solvent.

Para. 2. The process of Para. 1, wherein the organic solvent comprises one or more branched aliphatic compounds.

Para. 3. The process of Para. 2, wherein the one or more branched aliphatic compounds comprise isoparaffins.

Para. 4. The process of Para. 1, wherein the organic solvent comprises mineral oil.

Para. 5. The process of Para. 1, wherein the organic solvent comprises one or more alicyclic compounds.

Para. 6. The process of Para. 5, wherein the one or more alicyclic compounds include methylcyclohexane.

Para. 7. The process of any one of the preceding Paras., wherein the aluminoxane activator comprises methylaluminoxane.

Para. 8. The process of any one of the preceding Paras., wherein the organic solvent comprises one or more aromatic compounds in an amount from about 5 wt. % to about 45 wt. % with respect to the total amount of the organic solvent.

Para 9. The process of Para. 8, wherein the one or more aromatic compounds include toluene.

Para. 10. The process of any one of the preceding Paras., further comprising cooling the supported aluminoxane slurry to a temperature of about 50° C. or less before contacting the supported aluminoxane slurry with the single-site catalyst component.

Para. 11. The process of any one of the preceding Paras., wherein the organic solvent comprises one or more non-aromatic organic compounds having a boiling point greater than the highest temperature reached by the slurry in an amount of about 50 wt. % or greater.

Para 12. The process of any one of the preceding Paras., wherein the aluminoxane activator is added in an aromatic solvent to form the slurry.

Para. 13. The process of any one of the preceding Paras., wherein the process comprises separating the supported aluminoxane from the organic solvent before contacting it with the single-site catalyst component.

Para. 14. The process of any one of the preceding Paras., wherein the inorganic oxide comprises silica.

Para. 15. The process of any one of the preceding Paras., wherein the single-site catalyst component comprises a metallocene compound.

Para. 16. The process of any one of the preceding Paras., wherein the supported single-site catalyst has a total residual solvent content of less than about 50 wt %.

Para. 17. The process of Para. 16, wherein the supported single-site catalyst has a total residual solvent content of less than about 5 wt % or about 2 wt %.

Para. 18. The process of any one of the preceding Paras., wherein the supported single-site catalyst has a total residual aromatic solvent content of less than about 0.5 wt %.

Para 19. A process for producing a supported single-site catalyst comprising:
contacting a dried inorganic oxide support, an organic solvent, and an aluminoxane activator at a temperature from about 0° C. to about 50° C. to form a slurry;
heating the slurry to a temperature from about 100° C. to about 200° C. for a time period from about 0.5 to about 10 hours to form a supported aluminoxane slurry;
cooling the slurry to a temperature from about 0° C. to about 50° C.; and
adding a single-site catalyst component to the supported aluminoxane slurry to form a supported single-site catalyst;
wherein the organic solvent comprises one or more non-aromatic organic compounds having a boiling point of about 100° C. or greater in an amount of about 50 wt. % or greater with respect to the total amount of the organic solvent.

Para. 20. The process of Para. 19, wherein the organic solvent comprises one or more branched aliphatic compounds.

Para. 21. The process of Para. 20, wherein the one or more branched aliphatic compounds include isoparaffins.

Para. 22. The process of Para. 19, wherein the organic solvent comprises mineral oil.

Para. 23. The process of Para. 19, wherein the organic solvent comprises one or more alicyclic compounds.

Para. 24. The process of Para. 23, wherein the one or more alicyclic compounds include methylcyclohexane.

Para. 25. The process of any one of Paras. 19-24, wherein the aluminoxane activator comprises methylaluminoxane.

Para. 26. The process of any one of Paras. 19-25, wherein the organic solvent comprises one or more aromatic compounds in an amount from about 5 wt. % to about 45 wt. % with respect to the total amount of the organic solvent.

Para. 27. The process of Para. 26, wherein the one or more aromatic compounds include toluene.

Para. 28. The process of any one of Paras. 19-27, wherein the organic solvent comprises one or more non-aromatic organic compounds having a boiling point greater than the highest temperature reached by the slurry in an amount of about 50 wt. % or more.

Para. 29. The process of any one of Paras. 19-28, wherein the aluminoxane activator is added in an aromatic solvent to form the slurry.

Para. 30. The process of any one of Paras. 19-29, wherein the inorganic oxide comprises silica.

Para. 31. The process of any one of Paras. 19-30, wherein the supported single-site catalyst has a total residual solvent content of less than about 50 wt %.

Para. 32. The process of Para. 31, wherein the supported single-site catalyst has a total residual solvent content of less than about 5 wt % or about 2 wt %.

Para. 33. The process of any one of Paras. 19-32, wherein the supported single-site catalyst has a total residual aromatic solvent content of less than about 0.5 wt %.

Para. 34. The process of any one of the preceding Paras., further comprising contacting the supported single-site catalyst with an olefin monomer to produce a polyolefin.

Para. 35. A polyolefin produced by the process of Para. 34.

Para. 36. A supported single-site catalyst produced by the process of any one of Paras. 1-33.

Para. 37. A slurry comprising:
a dried inorganic oxide support;
an organic solvent comprising one or more non-aromatic organic compounds having a boiling point of about 100° C. or greater in an amount of about 50 wt. % or greater with respect to the total amount of the organic solvent; and
an aluminoxane activator.

Para. 38. The slurry of Para. 37, wherein the one or more non-aromatic organic compounds having a boiling point of about 100° C. or greater are present in an amount of about 75 wt. % or greater with respect to the total amount of the organic solvent.

Para. 39. The slurry of Para. 37 or 38, wherein the organic solvent comprises one or more branched aliphatic compounds.

Para. 40. The slurry of Para. 39, wherein the one or more branched aliphatic compounds comprise isoparaffins.

Para. 41. The slurry of Para. 37 or 38, wherein the organic solvent comprises mineral oil.

Para. 42. The slurry of Para. 37 or 38, wherein the organic solvent comprises one or more alicyclic compounds.

Para. 43. The slurry of Para. 42, wherein the one or more alicyclic compounds include methylcyclohexane.

Para. 44. The slurry of any one of Paras. 37-43, wherein the aluminoxane activator comprises methylaluminoxane.

Para. 45. The slurry of any one of Paras. 37-44, wherein the inorganic oxide comprises silica.

Para. 46. The process of any one of Paras. 37-45, wherein the slurry has a total residual solvent content of less than about 50 wt %.

Para. 47. The process of Para. 46, wherein the slurry has a total residual solvent content of less than about 5 wt % or about 2 wt %.

Para. 48. The process of any one of the preceding Paras. 37-47, wherein the slurry has a total residual aromatic solvent content of less than about 0.5 wt %.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof Δny listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A process for producing a supported single-site catalyst, the process comprising:
forming a slurry comprising a dried inorganic oxide support, an organic solvent, and an aluminoxane activator;
maintaining the temperature of the slurry from about 100° C. to about 200° C. for a time period from about 0.5 to about 10 hours to form a supported aluminoxane slurry; and
contacting the supported aluminoxane slurry with a single-site catalyst component to form a supported single-site catalyst;
wherein the organic solvent comprises one or more non-aromatic organic compounds having a boiling point of about 100° C. or greater in an amount of about 50 wt. % or greater with respect to the total amount of the organic solvent.

2. The process of claim 1, wherein the organic solvent comprises one or more branched aliphatic compounds comprising isoparaffins.

3. The process of claim 1, wherein the organic solvent comprises mineral oil.

4. The process of claim 1, wherein the organic solvent comprises one or more alicyclic compounds.

5. The process of claim 1, wherein the aluminoxane activator comprises methylaluminoxane.

6. The process of claim 1, wherein the organic solvent comprises one or more aromatic compounds in an amount from about 5 wt. % to about 45 wt. % with respect to the total amount of the organic solvent.

7. The process of claim 6, wherein the one or more aromatic compounds include toluene.

8. The process of claim 1, further comprising cooling the supported aluminoxane slurry to a temperature of about 50° C. or less before contacting the supported aluminoxane slurry with the single-site catalyst component.

9. The process of claim 1, wherein the organic solvent comprises one or more non-aromatic organic compounds having a boiling point greater than the highest temperature reached by the slurry in an amount of about 50 wt. % or greater.

10. The process of claim 1, wherein the aluminoxane activator is added in an aromatic solvent to form the slurry.

11. The process of claim 1, wherein the process comprises separating the supported aluminoxane from the organic solvent before contacting it with the single-site catalyst component.

12. The process of claim 1, wherein the inorganic oxide comprises silica, and/or wherein the single-site catalyst component comprises a metallocene compound.

13. The process of claim 1, wherein the supported single-site catalyst has a total residual solvent content of less than about 50 wt %, and/or wherein the supported single-site catalyst has a total residual aromatic solvent content of less than about 0.5 wt %.

14. A process for producing a supported single-site catalyst, the process comprising:
contacting a dried inorganic oxide support, an organic solvent, and an aluminoxane activator at a temperature from about 0° C. to about 50° C. to form a slurry;
heating the slurry to a temperature from about 100° C. to about 200° C. for a time period from about 0.5 to about 10 hours to form a supported aluminoxane slurry;
cooling the slurry to a temperature from about 0° C. to about 50° C.; and
adding a single-site catalyst component to the supported aluminoxane slurry to form a supported single-site catalyst;
wherein the organic solvent comprises one or more non-aromatic organic compounds having a boiling point of about 100° C. or greater in an amount of about 50 wt. % or greater with respect to the total amount of the organic solvent.

15. The process of claim 14, wherein the organic solvent comprises one or more branched aliphatic compounds comprising isoparaffins.

16. The process of claim 14, wherein the organic solvent comprises mineral oil.

17. The process of claim 14, wherein the organic solvent comprises one or more alicyclic compounds comprising methylaluminoxane.

18-23. (canceled)

24. The process of claim 14, wherein the supported single-site catalyst has a total residual solvent content of less than about 50 wt %, and/or wherein the supported single-site catalyst has a total residual aromatic solvent content of less than about 0.5 wt %.

25-27. (canceled)

28. A slurry comprising:
a dried inorganic oxide support;
an organic solvent comprising one or more non-aromatic organic compounds having a boiling point of about 100° C. or greater in an amount of about 50 wt. % or greater with respect to the total amount of the organic solvent; and
an aluminoxane activator.

29-33. (canceled)

34. The process of claim 28, wherein the slurry has a total residual solvent content of less than about 50 wt %, and/or wherein the supported single-site catalyst has a total residual aromatic solvent content of less than about 0.5 wt %.
